(19) United States
(12) Patent Application Publication
(10) Pub. No.: US 2026/0231043 A1
(43) Pub. Date: Aug. 6, 2026

(54) METHOD FOR OPERATING ELECTRONIC DEVICE AND NON-TRANSIENT COMPUTER READABLE STORAGE MEDIUM

(71) Applicant: Realtek Semiconductor Corporation, Hsinchu (TW)

(72) Inventor: Jinsheng HO, Hsinchu (TW)

(21) Appl. No.: 19/467,835

(22) Filed: Feb. 3, 2026

Related U.S. Application Data
(60) Provisional application No. 63/753,457, filed on Feb. 4, 2025.

(30) Foreign Application Priority Data
Dec. 18, 2025 (TW) 114150012

(51) Int. Cl. H04W 52/02

(52) U.S. Cl. CPC H04W 52/0274; H04W 52/0251

(57) ABSTRACT

A method includes: sensing the environment of the electronic device through a wireless module of the electronic device; controlling the wireless module to enter a first low power mode according to the wireless module sensing that a distance between a user and the electronic is greater than a first length; controlling the wireless module to leave the first low power mode according to the wireless module sensing that the distance between the user and the electronic changes from greater than the first length to smaller than the first length; and controlling a host of the electronic device to enter a sleep mode and the wireless module to enter a second low power mode according to the wireless module sensing that the distance between the user and the electronic is greater than a second length.

### CROSS - REFERENCE TO RELATED APPLICATION

This application claims priority to U.S. Provisional Application Serial Number 63/753,457 filed February 04, 2025, and Taiwan Application Serial Number 114150012, filed December 18, 2025, the disclosures of which are incorporated herein by reference in their entireties.

### BACKGROUND

### Description of Related Art

Wireless sensing is a technology used to monitor environment or physical condition through wireless communication. Specifically, wireless sensing typically involves the deployment of one or more transmitters and receivers in a space to transmit, receive, and analyze wireless signals, thereby establishing channel information to detect changes of objects within that space. Wireless sensing can be applied to various scenarios, including personnel localization, human activity recognition, scene modeling, and distance measurement, etc.

### SUMMARY

Some embodiments of the present disclosure provide a method for operating an electronic device. The method comprising: sensing an environment of the electronic device via a wireless module of the electronic device; controlling the wireless module to enter a first low power mode based on the wireless module sensing that a distance between a user and the electronic device is greater than a first length; controlling the wireless module to exit the first low power mode based on the wireless module sensing that the distance between the user and the electronic device changes from greater than the first length to less than the first length; controlling a host device of the electronic device to enter a sleep mode and the wireless module to enter a second low power mode based on the wireless module sensing that the distance between the user and the electronic device is greater than a second length, wherein the second length is greater than the first length, wherein power consumption of the wireless module in the second low power mode is less than power consumption of the wireless module in the first low power mode; and controlling the wireless module to exit the second low power mode based on the wireless module sensing that the distance between the user and the electronic device changes from greater than the second length to less than the second length.

Some embodiments of the present disclosure provide a non-transitory computer-readable storage medium for storing at least one program, wherein when an electronic device loads and executes the at least one program, the at least one program causes the electronic device to perform operations comprising: sensing an environment of the electronic device via a wireless module of the electronic device; controlling the wireless module to enter a first low power mode based on the wireless module sensing that a distance between a user and the electronic device is greater than a first length; controlling the wireless module to exit the first low power mode based on the wireless module sensing that the distance between the user and the electronic device changes from greater than the first length to less than the first length; controlling a host device of the electronic device to enter a sleep mode and the wireless module to enter a second low power mode based on the wireless module sensing that the distance between the user and the electronic device is greater than a second length, wherein the second length is greater than the first length, wherein power consumption of the wireless module in the second low power mode is less than power consumption of the wireless module in the first low power mode; and controlling the wireless module to exit the second low power mode based on the wireless module sensing that the distance between the user and the electronic device changes from greater than the second length to less than the second length.

### BRIEF DESCRIPTION OF THE DRAWINGS

The invention can be more fully understood by reading the following detailed description of the embodiment, with reference made to the accompanying drawings as follows:

FIG. 1 depicts an example of a system, in accordance with various embodiments of the present disclosure.

FIG. 2 depicts an example of the system, in accordance with various embodiments of the present disclosure.

FIG. 3 is a schematic diagram of the wireless device corresponding to FIGS. 1 to2 in accordance with various embodiments.

FIG. 4 is a schematic diagram of the wireless device corresponding to FIGS. 1 to 3.

FIG. 5 depicts architecture of the wireless device corresponding to FIGS. 1 to 4, in accordance with various embodiments of the present disclosure.

FIG. 6 depicts a finite-state machine (FSM) of the system corresponding to FIGS. 1 to 5, in accordance with various embodiments of the present disclosure.

FIG. 7 depicts a schematic diagram of the wireless device corresponding to FIGS. 1 to 6 in the active state, in accordance with various embodiments of the present disclosure.

FIG. 8 depicts a schematic diagram of the wireless device corresponding to FIGS. 1 to 7 in the power save state, in accordance with various embodiments of the present disclosure.

FIG. 9 depicts a schematic diagram of the wireless device corresponding to FIGS. 1 to 8 in the active sensing state, in accordance with various embodiments of the present disclosure.

FIG. 10 depicts a schematic diagram of the wireless device corresponding to FIGS. 1 to 9 in the low power sensing state, in accordance with various embodiments of the present disclosure.

FIG. 11 depicts a schematic diagram of the wireless device corresponding to FIGS. 1 to 10 in a WoW active state, according to some embodiments of the present disclosure.

FIG. 12 depicts a schematic diagram of the wireless device corresponding to FIGS. 1 to 11 in a WoW power save state, in accordance with various embodiments of the present disclosure.

FIG. 13 depicts a schematic diagram of the wireless device corresponding to FIGS. 1 to 12 in a WoW active sensing state, according to some embodiments of the present disclosure.

FIG. 14 depicts a schematic diagram of the wireless device corresponding to FIGS. 1 to 13 in the WoW low power sensing state, in accordance with various embodiments of the present disclosure.

FIG. 15 depicts an example of operations of the wireless device corresponding to FIGS. 1 to 14, in accordance to various embodiments of the present disclosure.

FIG. 16 is a flowchart of a method according to some embodiments of the present disclosure.

### DETAILED DESCRIPTION

Embodiments of the present disclosure will be described below with reference to the associated drawings. The same reference numerals and/or letters will be used throughout the drawings to refer to the same or like components or processes.

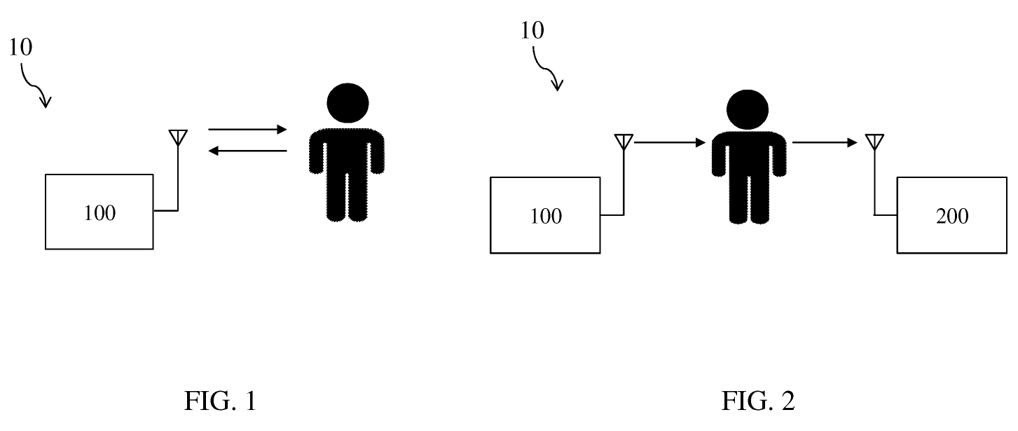

Reference is now made to FIG. 1. FIG. 1 depicts an example of a system 10, in accordance with various embodiments of the present disclosure. In some embodiments, the system 10 is a wireless sensing system including a wireless device 100. The wireless device 100 is an electronic device capable of receiving and transmitting wireless signals (e.g., WIFI signal).

In some embodiments, the system 10 is a monostatic wireless sensing system. In a monostatic wireless sensing system, the transmission and reception of wireless signals are located at the same position or within the same device, or the transmission and reception functions share the same antenna. A monostatic wireless sensing system performs sensing operations based on the signal transmission and reception of a single node.

As shown in FIG. 1, in some embodiments, the wireless device 100 emits wireless signal into the space through its transmitters. When the wireless signal encounters an object (e.g., a human body) in the environment, a reflected signal is generated. The receiver of the wireless device 100 receives the reflected signal. Then, the wireless device 100 performs processing of the reflected signal (e.g., transformation of the reflected signal into a current signal, and modulation, amplification, etc.) to extract data like channel state information (CSI) that contains environment information, received signal strength indicator (RSSI), etc.

These data reflect changes in amplitude and phase caused by environmental factors (such as human movement or changes in object positions) during signal propagation. In some embodiments, the wireless device 100 analyzes these data for operations like environment monitoring, motion detection, physiological signal monitoring, etc.

Reference is now made to FIG. 2. FIG. 2 depicts an example of the system 10, in accordance with various embodiments of the present disclosure. As shown in FIG. 2, in some embodiments, the system 10 further includes a wireless device 200, and the wireless device 100 is further configured to perform bistatic wireless sensing with the wireless device 200.

For example, in the bistatic wireless sensing operation, the wireless device 100 transmits data to the wireless device 200. Upon receiving the data, the wireless device 200 transmits an acknowledgment (ACK) message or reply data back to the wireless device 100. Subsequently, the wireless device 100 extracts environmental information from the acknowledgment message or the reply data to for sensing operations.

According to various embodiments, the system 10 can be a multistatic wireless sensing system including a plurality of the wireless devices 200, or a hybrid wireless sensing system that combines various modes such as monostatic, bistatic, and multistatic wireless sensing.

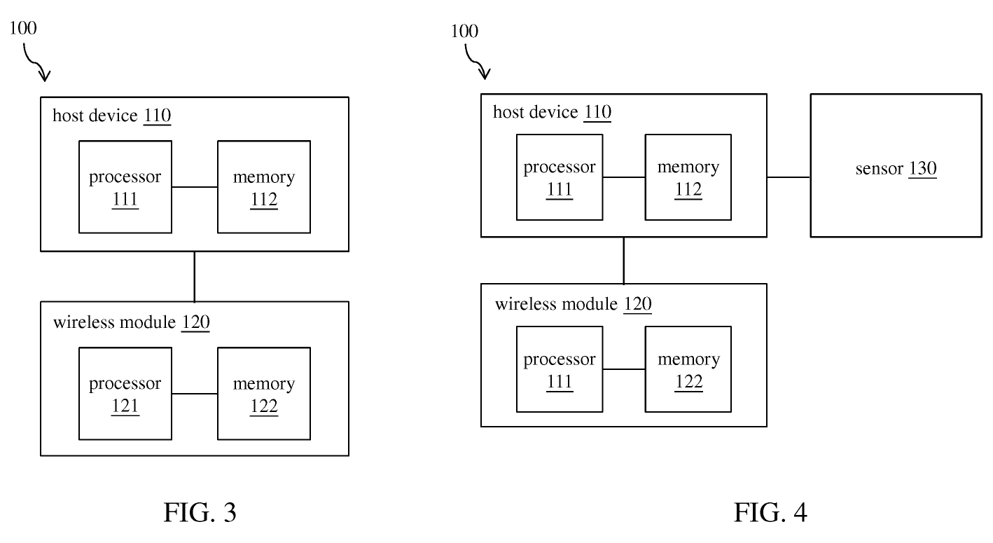

Reference is now made to FIG. 3. FIG. 3 is a schematic diagram of the wireless device 100 corresponding to FIGS. 1 to 2, in accordance with various embodiments. As shown in FIG. 3, in some embodiments, the wireless device 100 includes a host device 110 and a wireless module 120 coupled to the host device 110. The host device 110 is configured to control the wireless module 120 to perform wireless signal receiving and transmitting, and analyze data outputted from the wireless module 120 for implementing sense operation.

According to some embodiments, the host device 110 is a device used for data storage and processing, for example, a personal computer, laptop, mobile device, etc. The wireless module 120 may be a wireless communication circuit integrated into, embedded in, or externally connected to the host device 110, and is configured to support wireless communication protocols such as radio-frequency identification (RFID), radar, Wi-Fi, Bluetooth, ZigBee, etc. For example, the wireless module 120 may be a wireless network chip or a wireless network card.

In some embodiments, the host device 110 includes a processor 111 and a memory 112 coupled to the processor 111. The wireless module 120 includes a processor 121 and a memory 122 coupled to the processor 121.

In some embodiments, each of the processors 111 and 121 may be a central processing unit (CPU), a microprocessor, a digital signal processor (DSP), an application specific integrated circuit (ASIC), an arithmetic logic unit (ALU), a field programmable gate array (FPGA), or other similar components, or a combination of the aforementioned components.

In some embodiments, each of the memory 112 and 122 may be a random access memory (RAM), a read-only memory (ROM), a flash memory, a hard disk, or other similar components, or a combination of the aforementioned components.

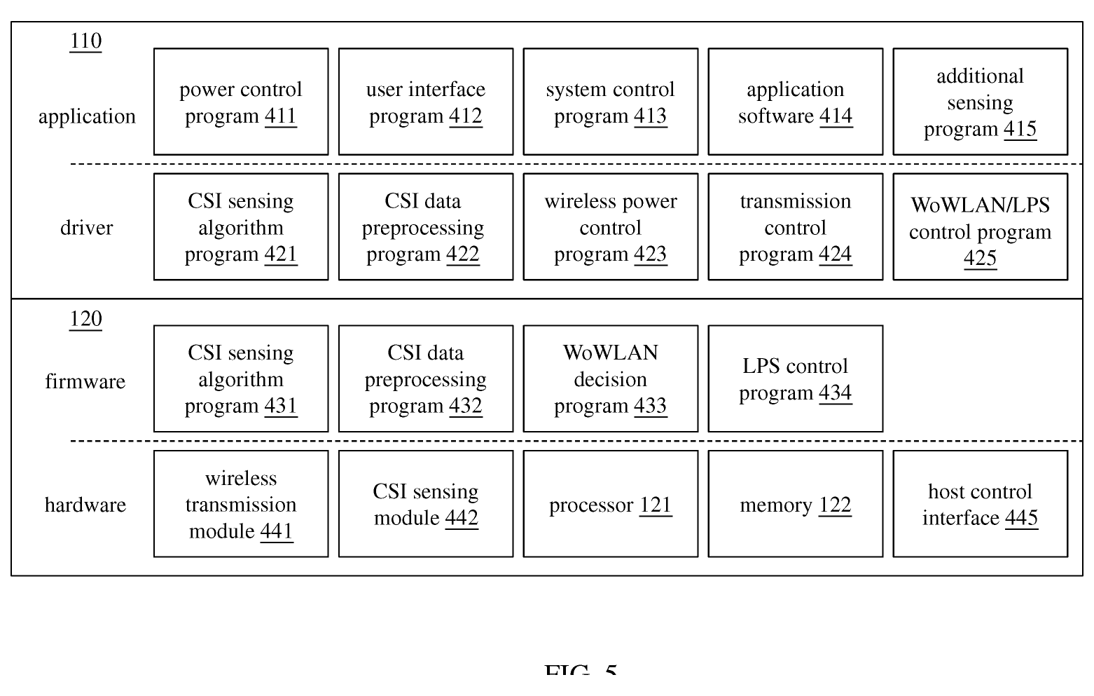

Reference is now made to FIG. 4. FIG. 4 is a schematic diagram of the wireless device 100 corresponding to FIG. 1 to FIG. 3. As shown in FIG. 4, in some embodiments, the wireless device 100 further includes a sensor 130. In some embodiments, the sensor 130 may be a sensor component or device, for example, an infrared sensor, a camera, etc.

In some embodiments, the wireless device 100 switches its state based on the wireless sensing results of the wireless module 120 and/or the sensing results of the sensor 130 to adjust performance and power consumption according to user and environmental changes, enabling the wireless device 100 to achieve better power efficiency while maintaining necessary performance.

Reference is now made to FIG. 5. FIG. 5 depicts architecture of the wireless device 100 corresponding to FIGS. 1 to 4, in accordance with various embodiments of the present disclosure.

According to some embodiments, as shown in FIG. 5, the wireless device 100 features a hierarchical architecture comprising an application layer, a driver layer, a firmware layer, and a hardware layer.

In some embodiments, the application layer and the driver layer belong to the host device 110. The application layer includes programs provided by the host device 110 to user. In some embodiments, the application layer includes a power control program 411, a user interface program 412, a system control program 413, application software 414, and an additional sensing program 415.

In some embodiments, the memory 112 is configured to store programs of the application layer and the driver layer. The processor 111 is configured to execute the programs of the application layer and the driver layer. For example, the memory 112 stores codes corresponding to the power control program 411, and the processor 111 executes the codes.

According to some embodiments, the power control program 411 is used to control power consumption parameters of the host device 110 and/or the switching of a power supply. The user interface program 412 is used to provide a user interface for the host device 110. The system control program 413 is used to perform process management, memory management, and the like for the host device 110. The additional sensing program 415 is used to control the sensor 130 to perform sensing operations and/or analyze sensing data of the sensor 130.

The driver layer includes programs for the host device 110 to control the wireless module 120. In some embodiments, the driver layer includes a CSI sensing algorithm program 421, a CSI data preprocessing program 422, a wireless power control program 423, a transmission (TRX) control program 424, and a wake on wireless LAN (WoWLAN)/legacy power saving (LPS) control program 425.

According to some embodiments, the CSI sensing algorithm program 421 is configured to determine parameters of the CSI sensing, for example, bandwidth, physical layer protocol data unit (PPDU) format, and sensing modes (such as monostatic, bistatic, or other wireless sensing modes), and/or analyzing data generated by the CSI sensing to generate sensing results. The CSI data preprocessing program 422 is configured to process the data generated by the CSI sensing. The wireless power control program 423 is used to determine power consumption parameters of the wireless module 120 and/or control the power switch of the wireless module 120. The transmission control program 424 is used to control data transmission between the host device 110 and the wireless module 120 and/or determine parameters for the data transmission. The WoWLAN/LPS control program 425 is used to determine WoWLAN/LPS parameters and/or control WoWLAN/LPS operations, such as the packet types for wake on wireless.

In some embodiments, the firmware layer and the hardware layer belong to the wireless module 120. The firmware layer includes programs of controlling hardware of the wireless module 120. In some embodiments, the firmware layer includes a CSI sensing algorithm program 431, a CSI data preprocessing program 432, a WoWLAN decision program 433, and a LPS control program 434.

According to some embodiments, the CSI sensing algorithm program 431 is configured to analyze the data generated by the CSI sensing to generate a sensing result. The CSI data preprocessing program 432 is configured to process the data generated by the CSI sensing. The WoWLAN decision program 433 is configured to perform WoWLAN operations according to the parameters and/or instructions of the WoWLAN/LPS control program 425, for example, the WoWLAN decision program 433 awakens the host device 110 according to a preset packet type. The LPS control program 434 is used to perform LPS operations according to the parameters and/or instructions of the WoWLAN/LPS control program 425.

The hardware layer includes the hardware of the wireless module 120. In some embodiments, the hardware layer includes a wireless transmission (TRX) module 441, a CSI sensing module 442, a processor 121, a memory 122, and a host control interface (HCI) 445.

According to some embodiments, the wireless transmission module 441 is configured to perform wireless data transmission. The CSI sensing module 442 is configured to perform wireless sensing to generate the CSI data. The host control interface 445 is configured to connect to and communicate with the host device 110. For example, the host control interface 445 is configured to receive commands from the host device 110 and returning events or data generated by the wireless module 120 to the host device 110 to achieve control and data exchange between the host device 110 and the wireless module 120. In some embodiments, the processor 121 is a multi-core processor.

In some embodiments, the memory 112 is configured to store the programs of the firmware layer. The processor 121 is configured to execute the programs of the firmware layer.

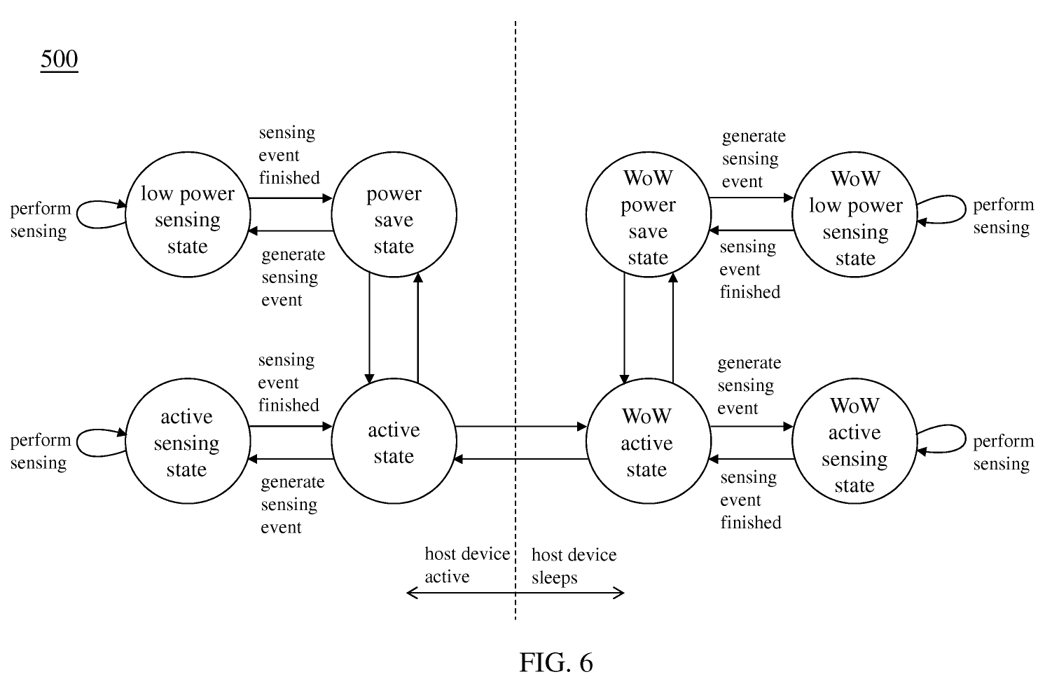

Reference is now made to FIG. 6. FIG. 6 depicts a finite-state machine (FSM) 500 of the system 10 corresponding to FIG. 1 to FIG. 5, in accordance with various embodiments of the present disclosure.

In some embodiments, the FSM 500 shows different states of the wireless device 100 and the switching between these states. As shown in FIG. 6, the FSM 500 includes the following states: activate state, power save state, active sensing state, low power sensing state, wake on wireless (WoW) active state, WoW power save state, WoW active state, and WoW low power sensing state. In some embodiments, the memory 112 and/or the memory 122 are configured to store conditions for entering each state. The wireless device 100 switches to a corresponding state based on which state's condition is satisfied.

According to some embodiments, in the active state, the host device 110 is active. According to some embodiments, the wireless device 100 enters the active state when an event (e.g., application) of the host device 110 is being processed or to be processed, or data is being transmitted through the wireless module 120.

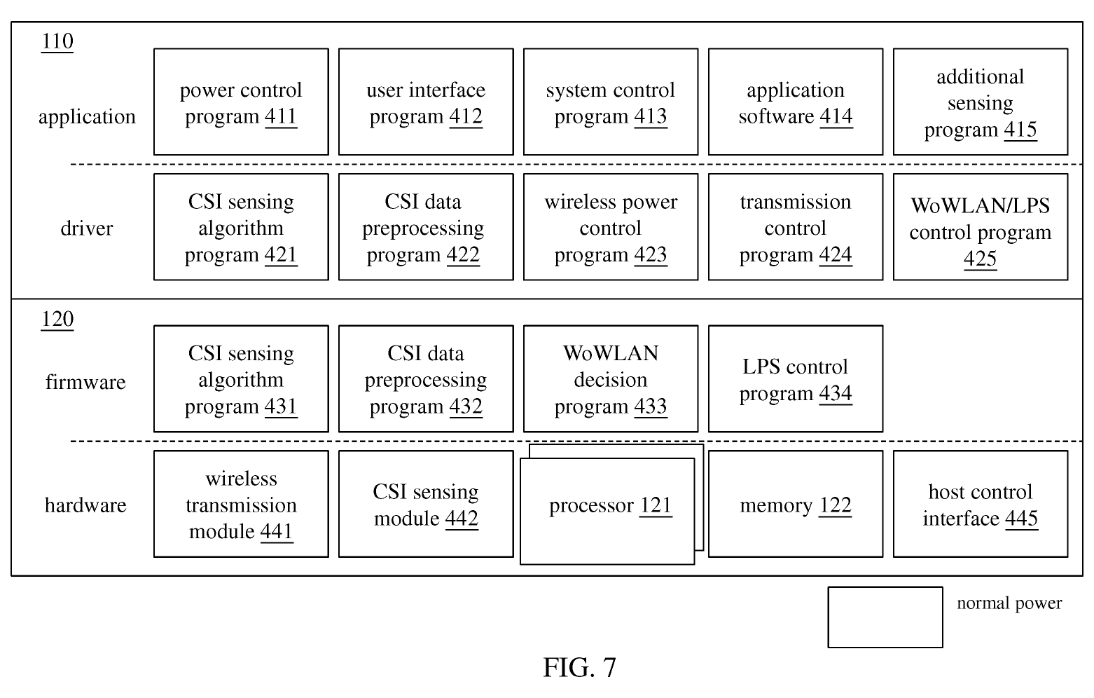

Reference is now made to FIG. 7. FIG. 7 depicts a schematic diagram of the wireless device 100 corresponding to FIGS. 1 to 6 in the active state, in accordance with various embodiments of the present disclosure.

As shown in FIG. 7, in the active state, components of the wireless device 100 are activated and exhibit normal power consumption. In other words, the components of the wireless device 100 are neither powered off nor in a low power mode.

In some embodiments, when the host device 110 is active and the host device 110 detects that the wireless device 100 satisfies the condition of the power save state, the wireless device 100 enters the power save state from the active state to optimize battery life and power consumption performance.

For example, in some embodiments, when the user manually controls the wireless device 100 to enter the low power mode (e.g., decreasing the power consumption of the wireless device 100 through the power control program 411), the wireless device 100 enters the power save state from the active state.

In some embodiments, when the host device 110 detects that the host device 110 is idle or the battery of the wireless device 100 is low (e.g., battery level being below a predetermined value), the wireless device 100 enters the power save state from the active state.

In some embodiments, when the host device 110 determines that the predetermined condition of the wireless sensing (e.g., detecting the user leaving the host device 110) is met, the wireless device 100 enters the power save state from the active state.

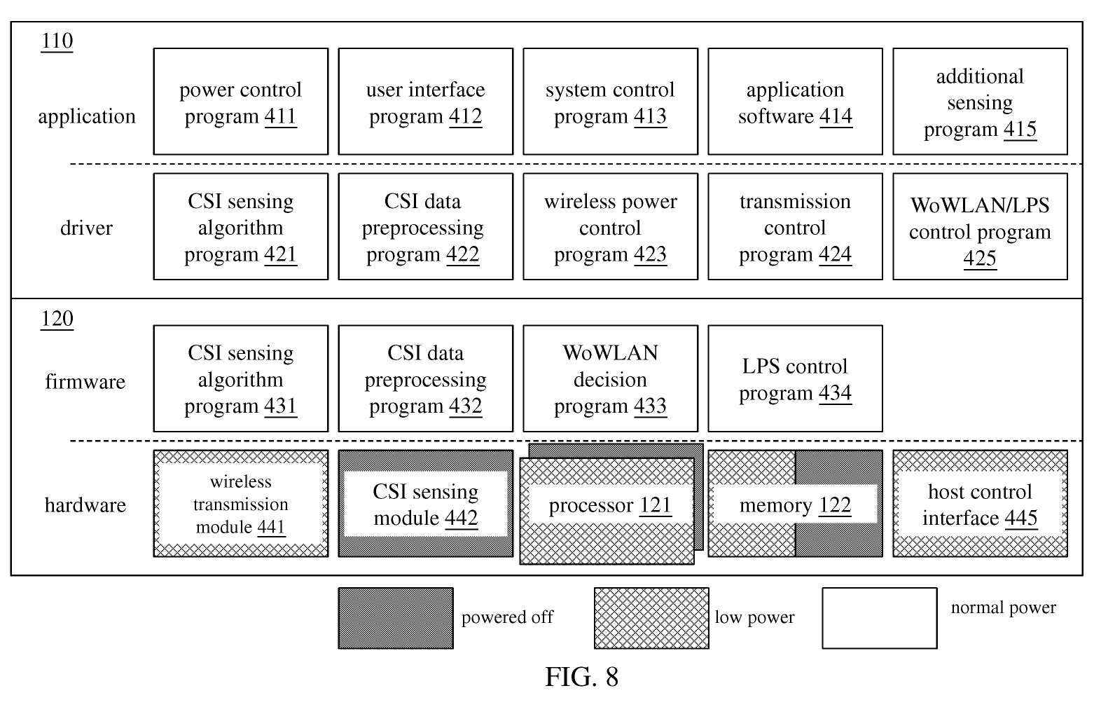

Reference is now made to FIG. 8. FIG. 8 depicts a schematic diagram of the wireless device 100 corresponding to FIGS. 1 to 7 in the power save state, in accordance with various embodiments of the present disclosure.

As shown in FIG. 8, in the power save state, the wireless device 100 powers off the CSI sensing module 442 and a portion of the memory 122, and the wireless device 100 places the wireless transmission module 441, the processor 121, the remaining portion of the memory 122 and the host control interface 445 into the low power mode.

According to some embodiments, when the wireless device 100 places a component into the low power mode, the wireless device 100 decrease values of parameters like bandwidth, clock frequency, power, data transfer rate of the component, and/or adopts a low power data transmission mode for the component.

In some embodiments, in the low power mode, some of the cores of the processor 121 are powered off. In some embodiments, in the low power mode, the memory 122 enters a data retention mode. In some embodiments, in the low power mode, a portion of arrays of the memory 122 are powered off.

In some embodiments, when the host device 110 detects any peripheral device or component (e.g., mouse, key board, etc.) function or data needed to be transmitted, the wireless device 100 enters active state from power save state.

In some embodiments, when the host device 110 determines that the result of the wireless sensing satisfies the active state (e.g., the user getting close to the host device 110), the wireless device 100 enters the active state from the power save state.

Reference is made to FIG. 6, in some embodiments, the wireless device 100 switches between the active state and the active sensing state to perform wireless sensing.

Specifically, the wireless device 100 switches between the active state and the active sensing state according to a sample rate. In some embodiments, the memory 112 is configured to store predetermined sample rate or sample cycle time. The sample rate and the sample cycle time indicate the frequency and cycle time used to perform wireless sensing.

For example, when the wireless device 100 is in the active state for over the sample cycle time, the wireless device 100 generates a sensing event and enters the active sensing state.

In the active sensing state, the wireless device 100 performs the wireless sensing operation. When the wireless sensing operation ends, the wireless device 100 finishes the sensing event and returns to the active state.

In the active sensing state, the wireless device 100 sets parameters like the bandwidth, power, physical layer protocol data unit (PPDU) format and sensing mode (single-station, dual-station, or other wireless sensing modes) into states that provide best performance of the wireless sensing (e.g., having maximum data transfer rate).

For example, the memory 112 stores what states of the parameters provide the best performance predetermined by the user. In the active sensing state, the wireless device 100 performs the wireless sensing operation with the parameters in the states providing the best performance.

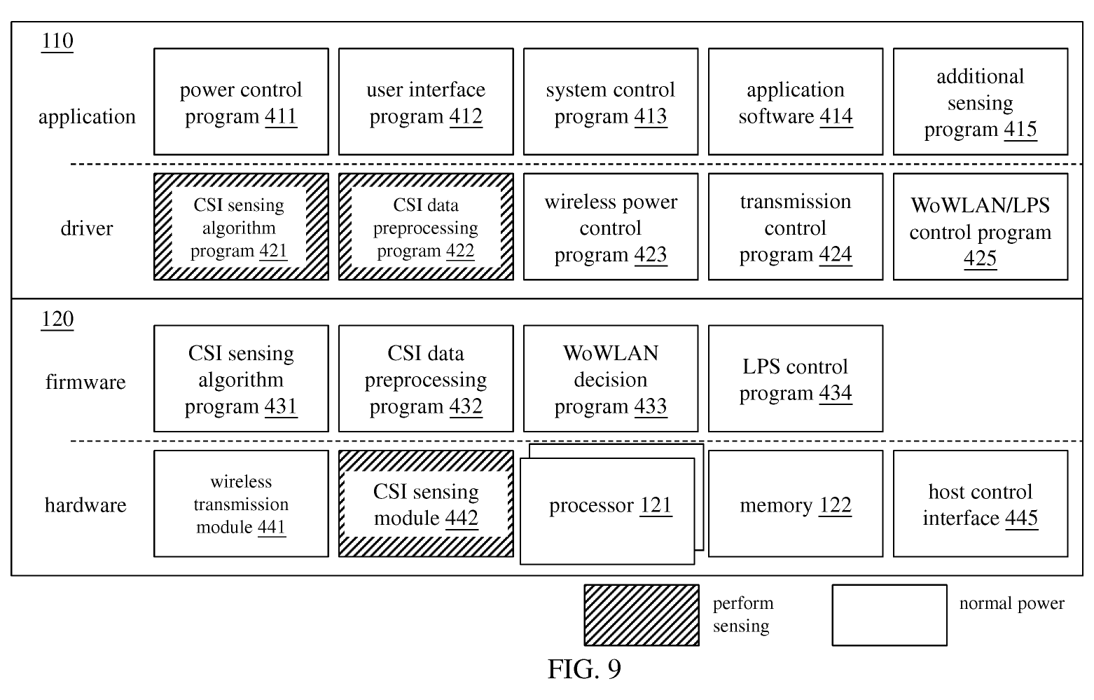

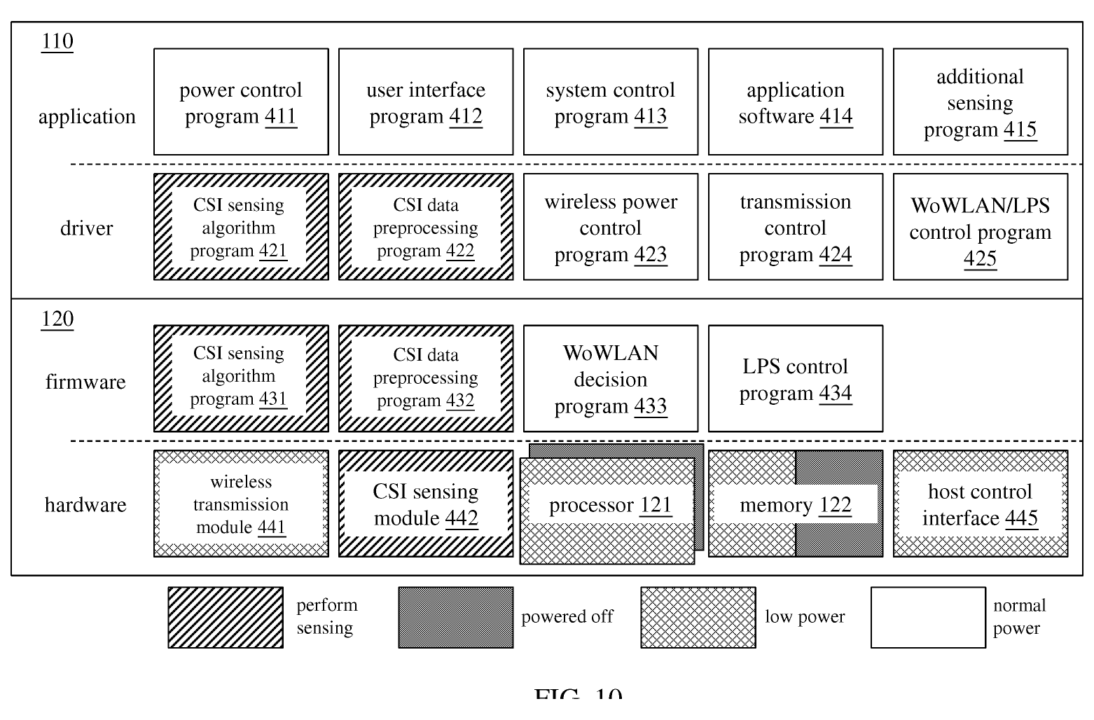

Reference is now made to FIG. 9. FIG. 9 depicts a schematic diagram of the wireless device 100 corresponding to FIGS. 1 to 8 in the active sensing state, in accordance with various embodiments of the present disclosure.

As shown in FIG. 9, in the active sensing state, the wireless device 100 performs wireless sensing operation through the CSI sensing algorithm program 421, the CSI data preprocessing program 422 and the CSI sensing module 442 to perform wireless sensing operation.

According to some embodiments, in the active sensing state, the wireless device 100 uses the host device 110 to analyze the data generated by the CSI sensing module 442 without using the wireless module 120 so as to perform faster and/or precise wireless sensing.

Reference is now made to FIG. 6 again, in some embodiments, the wireless device 100 switches between the power save state and the low power sensing state according to the sample rate of sample cycle time to perform the wireless sensing.

For example, when the wireless device 100 is in the power save state for over the sample cycle time, the wireless device 100 enters the low power sensing state.

In the low power sensing state, the wireless device 100 performs the wireless sensing operation. When the wireless sensing operation is finished, the wireless device 100 returns to the active state.

In the low power sensing state, the wireless device 100 sets its parameters like the bandwidth, power, PPDU format and sensing mode into states that provide a lower power. For example, the wireless device 100 adjusts the parameters to ensure achieving the lowest possible power consumption while maintaining the efficacy of wireless sensing operations.

Reference is now made to FIG. 10. FIG. 10 depicts a schematic diagram of the wireless device 100 corresponding to FIGS. 1 to 9 in the low power sensing state, in accordance with various embodiments of the present disclosure.

As shown in FIG. 10, when switching from the power save state to the low power sensing state, the wireless device 100 maintains a portion of the memory 122 (e.g., some of its memory arrays) powered off. The wireless device 100 maintains the wireless transmission module 441, the processor 121, the remaining of the memory 122 and the host control interface 445 in the low power mode.

In the low power sensing state, the wireless device 100 performs the wireless sensing operation through the CSI sensing algorithm program 421, the CSI data preprocessing program 432 and the CSI sensing module 442 to perform the wireless sensing operation.

According to some embodiments, in comparison to the CSI sensing algorithm program 421 and the CSI data preprocessing program 422, the CSI sensing algorithm program 431 and the CSI data preprocessing program 432. Consequently, compared to merely using the CSI sensing algorithm program 421 and the CSI data preprocessing program 422 to analyze the CSI data, using the CSI sensing algorithm program 431 and the CSI data preprocessing program 432 to share a portion of the workload of the CSI data analysis can help lower the power consumption of the wireless device 100.

Reference is made to FIG. 6 again, in some embodiments, when the host device 110 enters a sleep mode according to user input (e.g., according to the user inputting a sleep command or pressing a physical sleep button), the wireless device 100 enter the WoW active state from the active state. In the WoW active state, the host device 110 is at a sleep mode, and the wireless module 120 is active.

In some embodiments, when the host device 110 detects the battery lower than a predetermined value or other sleep conditions of the host device 110 stored in the memory 112 are met, the wireless device 100 enters the WoW active state from the active state.

In some embodiments, when the host device 110 determines that the result of the wireless sensing meets the conditions of the WoW active state (e.g., detecting no motion in the environment) stored in the memory 112, the wireless device 100 enters the WoW active state from the active state. Specifically, when states of objects in the environment do not change (e.g., no object moves or changes position) for a specific time interval, the wireless device 100 detects that no motion in the environment.

In some embodiments, the host device 110 is awakened from the sleep mode and the wireless device 100 transitions from a WoW active state to the active state when a specific local host event (e.g., system update and timer event) or peripheral events (e.g., actions from other sensors or peripheral devices) occur.

For example, when a wake-up time for a timer event is reached, the host device 110 is awakened from the sleep mode and the wireless device 100 transitions from the WoW active state to the active state. When the wireless module 120 receives a wake-up packet, the wireless module 120 transmits a message to the host device 110, the host device 110 is awakened, and the wireless device 100 transitions from the WoW active state to the active state.

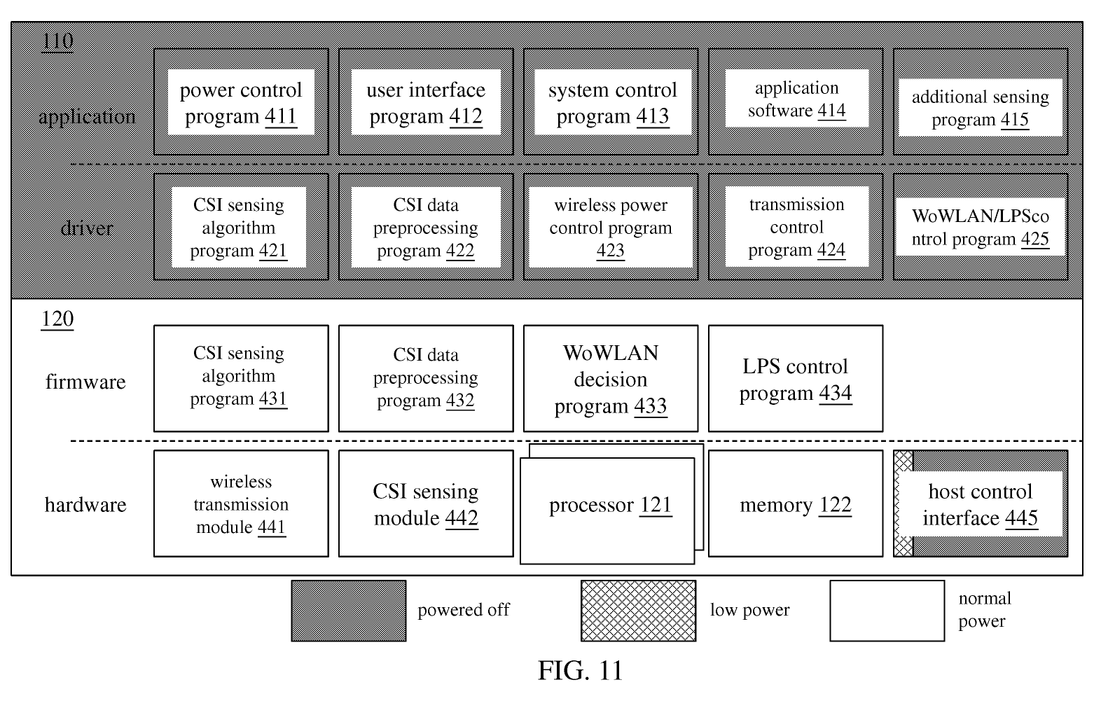

Reference is now made to FIG. 11. FIG. 11 depicts a schematic diagram of the wireless device 100 corresponding to FIGS. 1 to 10 in a WoW active state, according to some embodiments of the present disclosure.

As shown in FIG. 11, in the WoW active state, the host device 110 is in the sleep mode. According to some embodiments, when the host device 110 is in the sleep mode, the application layer and the driver layer of the wireless sensing are powered off. For example, the power control program 411, the user interface program 412, the system control program 413, the application software 414, the additional sensing program 415, the CSI sensing algorithm program 421, the CSI data preprocessing program 422, the wireless power control program 423, the transmission control program 424, and the WoWLAN/LPS control program 425 are inactive and do not consume power.

In some embodiments, in the WoW active state, a majority of the host control interface 445 is powered off, and only essential portions are in the low power mode. For example, within the host control interface 445, only the portion that executes handshake operations with the host device 110 remains powered on.

Reference is made to FIG. 6 again, when the host device 110 detects that the wireless module 120 satisfies the condition for entering the WoW power save state, the wireless device 100 transitions from the WoW active state to the WoW power save state.

For example, the wireless device 100 transitions from the WoW active state to the WoW power save state based on the wireless module 120 detecting that the host event, the transmission (TRX) state of the host device 110, and other factors satisfy the required conditions.

In some embodiments, when the wireless sensing result of the wireless module 120 satisfies a predefined wireless sensing condition (e.g., detecting no motion in the environment), the wireless device 100 transitions from the WoW active state to the WoW power save state.

According to some embodiments, the wireless device 100 has the lowest power consumption when in the WoW power save state. The power consumption of the wireless module 120 in the low power mode of the WoW power save state is lower than the power consumption of the wireless module 120 in the low power mode of the power save state.

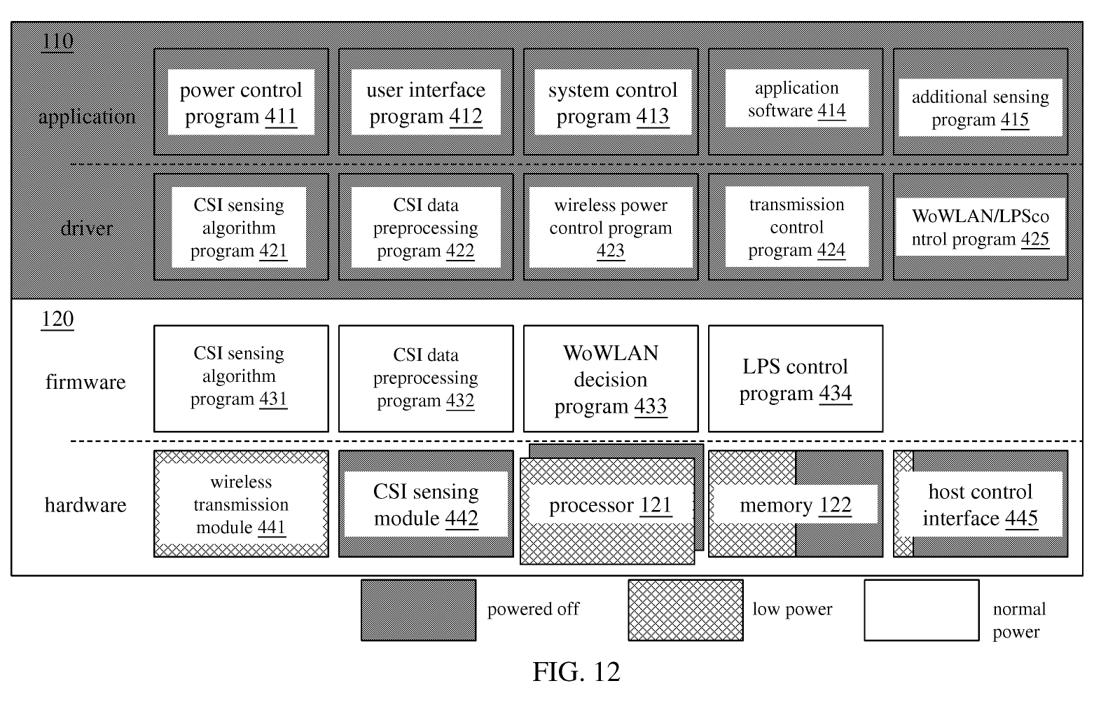

Reference is now made to FIG. 12. FIG. 12 depicts a schematic diagram of the wireless device 100 corresponding to FIGS. 1 to 11 in a WoW power save state, in accordance with various embodiments of the present disclosure.

As shown in FIG. 12, in the WoW power save state, the host device 110 remains in the sleep mode. A majority of the host control interface 445 remains powered off, and only essential portions are in the low power mode.

Additionally, the wireless device 100 powers off the CSI sensing module 442 and a portion of the memory 122. The wireless device 100 causes the wireless transmission module 441, the processor 121, and the remaining portion of the memory 122 to enter the low power mode.

Reference is made to FIG. 6 again. In some embodiments, the wireless device 100 switches between the WoW active state and the WoW active sensing state according to the predetermined sample rate or sample cycle time to perform the wireless sensing.

For example, when the wireless device 100 has been in the WoW active state for longer than the sample cycle time, the wireless device 100 enters the WoW active sensing state.

In the WoW active sensing state, the wireless device 100 performs wireless sensing operations. When the wireless sensing operations are completed, the wireless device 100 returns to the active state.

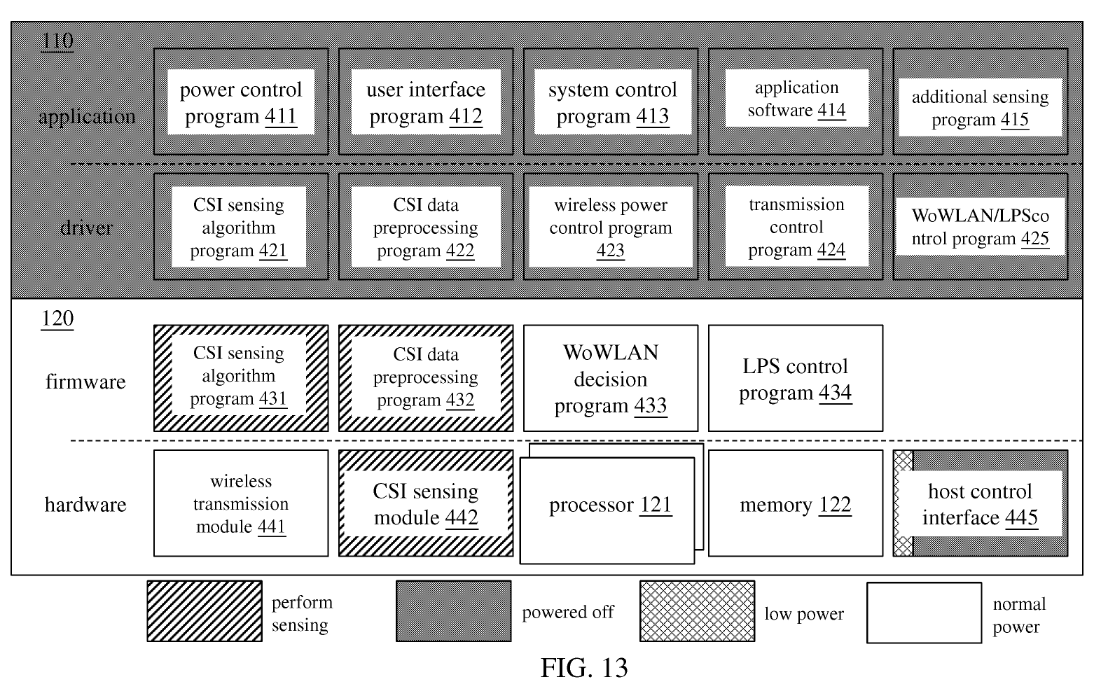

Reference is made to FIG. 13. FIG. 13 depicts a schematic diagram of the wireless device 100 corresponding to FIGS. 1 to 12 in a WoW active sensing state, according to some embodiments of the present disclosure.

As shown in FIG. 13, when switching from the WoW active state to the WoW active sensing state, the host device 110 remains in the sleep mode. A majority of the host control interface 445 remains powered off, and only essential portions are in the low power mode.

In the WoW active sensing state, the wireless device 100 performs wireless sensing operations through the CSI sensing algorithm program 431, the CSI data preprocessing program 432, and the CSI sensing program 442.

Reference is made to FIG. 6, the wireless device 100 switches between the WoW power save state and the WoW low power sensing state according to a predetermined sample rate or sample cycle time to perform the wireless sensing.

For example, when the wireless device 100 is in the WoW power save state for longer than the sample cycle time, the wireless device 100 enters the WoW low power sensing state.

In the WoW low power sensing state, the wireless device 100 performs wireless sensing operations. When the wireless sensing operations are completed, the wireless device 100 returns to the WoW power save state.

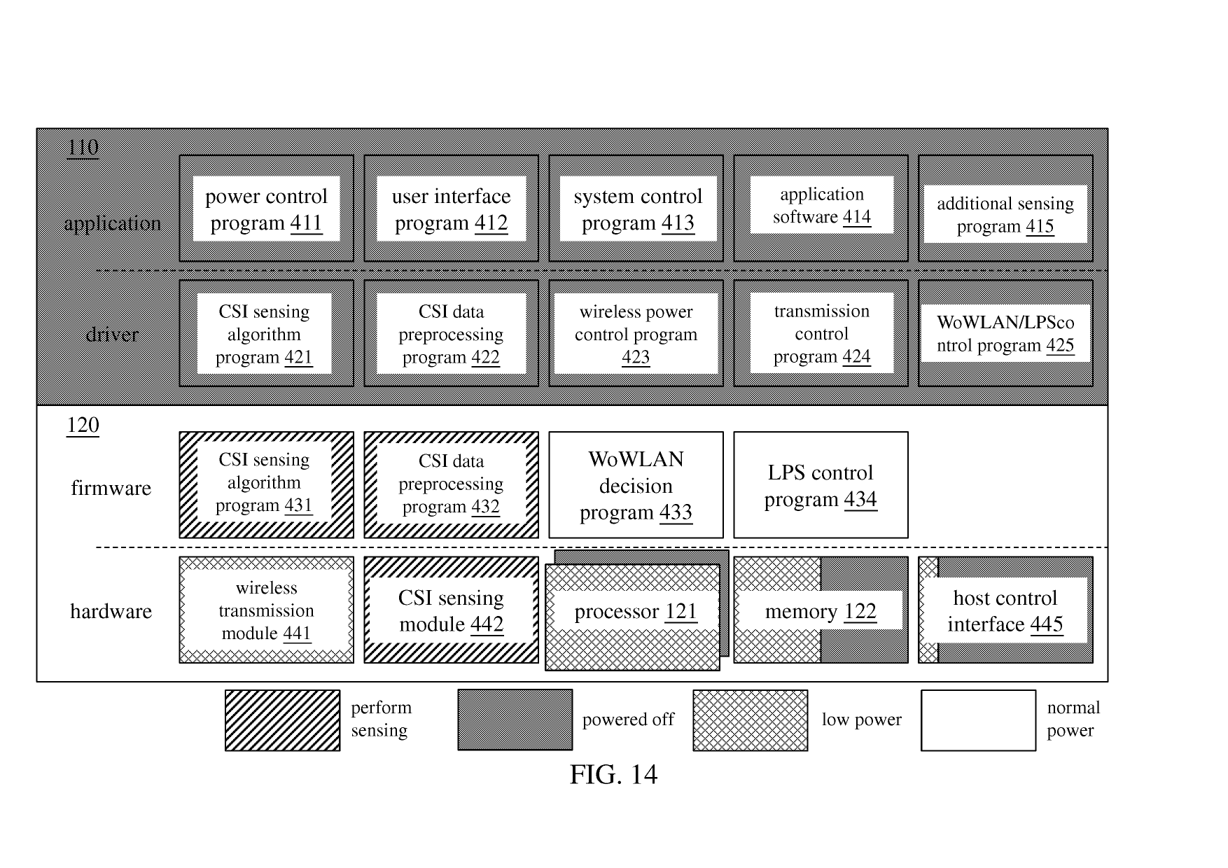

Reference is now made to FIG. 14. FIG. 14 depicts a schematic diagram of the wireless device 100 corresponding to FIGS. 1 to 13 in the WoW low power sensing state, in accordance with various embodiments of the present disclosure.

As shown in FIG. 14, when switching from the WoW power save state to the WoW low power sensing state, the host device 110 remains in the sleep mode. The wireless module 120 maintains a portion of the memory 122 and the host control interface 445 powered off. The wireless module 120 maintains the wireless transmission module 441, the processor 121, the remaining portion of the memory 122, and the remaining portion of the host control interface 445 in the low power mode.

In the WoW low power sensing state, the wireless device 100 performs the wireless sensing operation through the CSI sensing algorithm program 431, the CSI data preprocessing program 432, and the CSI sensing module 442.

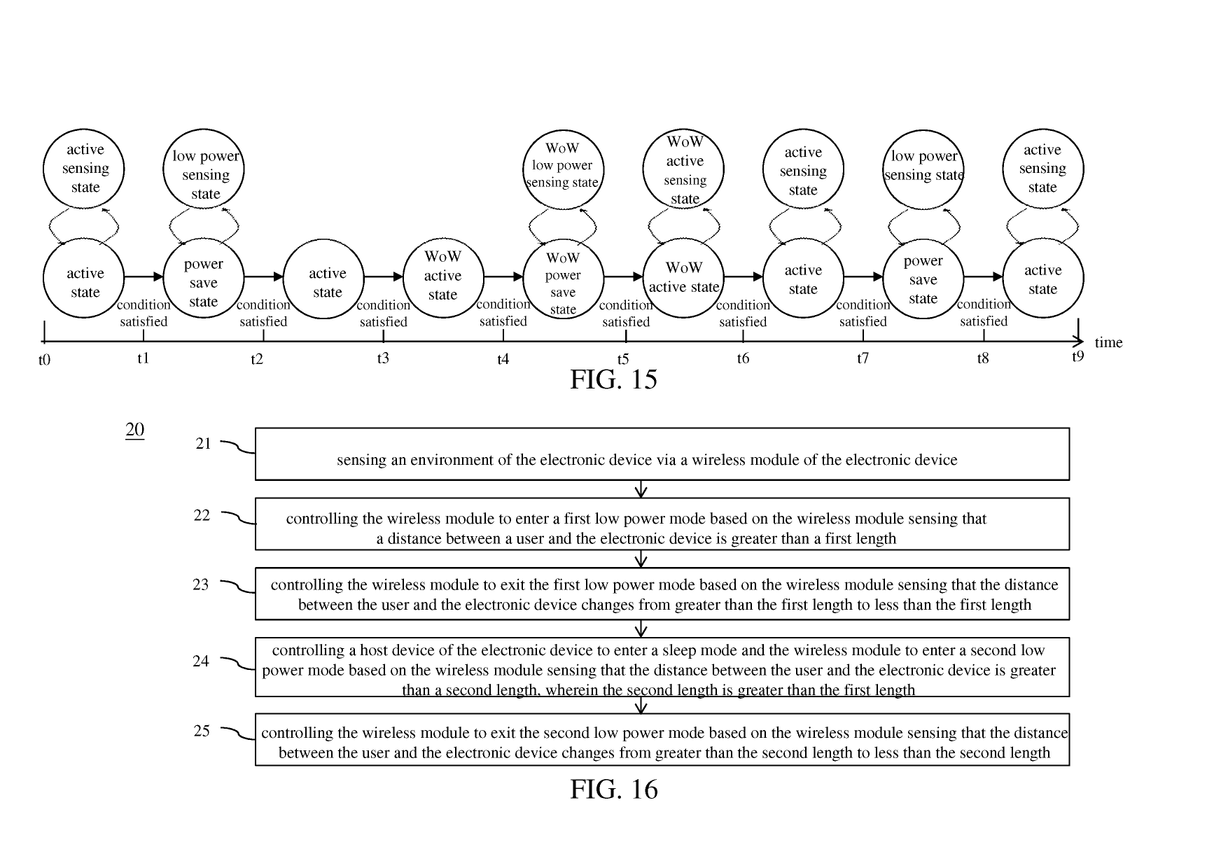

Reference is now made to FIG. 15. FIG. 15 depicts an example of operations of the wireless device 100 corresponding to FIGS. 1 to 14, in accordance to various embodiments of the present disclosure.

Specifically, FIG. 15 depicts the wireless device 100 performing state switching based on the wireless sensing results from a time point t0 to a time point t9.

In the example of FIG. 15, the wireless sensing results of the wireless device 100 include the following types: close-range detection, mid-range detection, long-range detection, and no-motion detection. The close-range detection includes user standard mode detection, user idle mode detection, and user concentration mode detection.

Specifically, when the wireless device 100 senses that a user is within a close range (e.g., 60 cm), the wireless sensing result is the close-range detection. When the wireless device 100 senses that the user is between the close range and a mid-range (e.g., 2 meters), the wireless sensing result is the mid-range detection. When the wireless device 100 senses that the user is between the mid-range and a long-range (e.g., 5 meters), the wireless sensing result is long-range detection.

When the wireless device 100 senses that there is no motion in the environment (e.g., a room), the wireless sensing result is no-motion detection.

When the wireless device 100 and/or the sensor 130 sense that the user's face is near a specific part (e.g., a screen) of the host device 110 (e.g., within 60 cm) and the user's eyes are aligned with this specific part of the host device 110, the wireless sensing result is the user standard mode detection.

In some embodiments, the sensor 130 performs eye tracking to generate eye sight data indicating the user's gaze direction, and the host device 110 determines whether the user's eyes are aligned with the specific part of the host device 110 based on the eye sight data.

When the wireless device 100 and/or the sensor 130 sense that the user's face is near the specific part (e.g., a screen) of the host device 110 (e.g., within 60 cm) but the user's eyes are not aligned with this specific part of the host device 110, the wireless sensing result is user idle mode detection.

When the wireless device 100 and/or the sensor 130 sense that the user's face is extremely close to the specific part (e.g., a screen) of the host device 110 (e.g., within 40 cm) and the user's eyes are aligned with this specific part of the host device 110, the wireless sensing result is the user concentration mode detection.

For example, at the time point t0, the user turns on the wireless device 100. In some embodiments, the active state is the default state of the wireless device 100. Therefore, when the wireless device 100 is turned on, the wireless device 100 first enters the active state.

After turning on the wireless device 100, the user sits in front of the host device 110 (within the close range) and uses an application, such as browsing a webpage, through the host device 110. During this period, the wireless device 100 periodically switches to the active sensing state according to the predetermined sample rate or sample cycle time to perform the wireless sensing.

After completing the wireless sensing, the wireless device 100 returns to the active state. Subsequently, the wireless device 100 determines which state to enter based on the result of the wireless sensing.

Since the user's face is near the screen of the host device 110 and is gazing at the screen, the wireless sensing result of the wireless device 100 and/or the result from other sensors indicate that the condition for user standard mode detection is satisfied. After the condition for the user standard mode detection is satisfied, the wireless device 100 remains in the active state.

After the user has used the host device 110 for a period of time, the user leaves the host device 110. While the user is away from the host device 110, the wireless device 100 periodically switches to the active sensing state to perform the wireless sensing and then switches back to the active state.

Subsequently, at the time point t1, the wireless device 100 determines that the user is at a mid-range distance from the host device 110 based on the wireless sensing. The wireless sensing result transitions from close-range detection to the mid-range detection, and the condition for the power save state is satisfied, the wireless device 100 enters the power save state.

After entering the power save state, the wireless device 100 periodically switches to the low power sense state to perform the wireless sensing according to the predetermined sample rate or sample cycle time.

When the user completely leaves the room, the wireless device 100 determines that the user is far away from the host device 110 according to that the wireless sensing result is no-motion detection while in the power save state. As the wireless sensing result changes from the mid-range detection to the long-range detection, and to the no-motion detection, the condition for the WoW power save state is satisfied, and the wireless device 100 enters the WoW power save state.

In some embodiments, switching from the power save state to the WoW power save state must pass through the active state and the WoW active state. As shown in FIG. 15, because the condition for no-motion detection is satisfied, the wireless device 100 switches to the active state at the time point t2, switches to the WoW active state at the time point t3, and finally enters the WoW power save state at the time point t4.

After entering the WoW power save state, the wireless device 100 periodically switches to the WoW low power sensing state to perform wireless sensing and switches back to the WoW power save state according to a predetermined sample rate or sample cycle time.

During the period while the user is away from the room, the wireless device 100 remains in the WoW power save state based on the no-motion detection result and periodically switches to the WoW low power sensing state to maintain continuous sensing.

In the example of FIG. 15, when the user returns to the room, the wireless device 100 is in the WoW low power sensing state and detects object motion. Based on the sensing result, the wireless device 100 transitions from the WoW power save state to the WoW active state to more accurately sense the environment and the distance of the object. Once the user returns to the front of the host device 110, the wireless module 120 awakens the host device 110, and the wireless device 100 enters the active state to resume normal operations.

Specifically, when the user returns to the room, the wireless module 120 senses the user entering the long range; the sensing result changes from the no-motion detection to the long-range detection, and the condition for the WoW active state is satisfied. At the time point t5, based on the sensing result being the long-range detection, the wireless device 100 transitions from the WoW power save state to the WoW active state.

Subsequently, the wireless device 100 periodically switches between the WoW active state and the WoW active sensing state to perform the wireless sensing.

When the user returns to the front of the host device 110, the wireless module 120 senses the user entering the close range. At the time point t6, based on the sensing result being close-range detection, the wireless device 100 transitions from the WoW active state to the active state. The wireless module 120 awakens the host device 110.

Subsequently, the wireless device 100 periodically switches between the active state and the active sensing state to perform the wireless sensing.

When the user uses the host device 110 in front of the host device 110 (e.g., browsing a webpage), the wireless module 120 and/or the sensor 130 senses that a user is within the close range and that the condition for the user standard mode detection is satisfied. The wireless device 100 remains in the active state based on the result being the standard mode detection.

When the user is in front of the host device 110 but stops operating the host device 110 and the user’s attention is not on the host device 110 (e.g., turning head to read a newspaper), the sensing of the wireless module 120 and/or the sensor 130 satisfies the condition for the user idle mode. At the time point t7, the wireless device 100 enters the power save state because the condition for the user idle mode is satisfied.

Subsequently, the wireless device 100 periodically switches between the power save state and the low power sensing state to perform the wireless sensing. When the result from the wireless module 120 and/or the sensor 130 still satisfies the condition for the user idle mode, the wireless device 100 remains in the power save state.

When the user remains in front of the host device 110 and turns attention back to the host device 110, such as by gazing at the host, the result from the wireless module 120 and/or the sensor 130 satisfies the condition for the user concentration mode. At the time point t8, the wireless device 100 enters the active state because the condition for the user concentration mode is satisfied.

Subsequently, the wireless device 100 periodically switches between the active state and the active sensing state to perform the wireless sensing. When the sensing result of the wireless module 120 and/or other sensors still satisfies the condition for the user concentration mode, the wireless device 100 remains in the active state.

Reference is now made to FIG. 16. FIG. 16 is a flowchart of a method 20 according to some embodiments of the present disclosure. It should be understood that additional operations may be provided before, during, and after the operations shown in FIG. 16, and for other embodiments of the method 20, some operations described below may be replaced or removed. At least some operations in the method 20 may be used to operate the system 10 and the wireless device 100 in FIGS. 1 to 15. The method 20 includes operations 21 to 25, which will be discussed below.

In operation 21, the wireless device 100 senses the environment of the wireless device 100 via the wireless module 120. Specifically, the wireless module 120 generates sensing data for the space within the maximum sensing range of the system 10. For example, the wireless module 120 performs wireless sensing to an area within a 10-meter radius of the wireless device 100 to generate sensing data.

In operation 22, the wireless device 100 controls the wireless module 120 to enter a first low power mode based on the wireless module 120 sensing that the user's distance from the wireless device 100 is greater than a first length (e.g., 60 cm).

For example, when the wireless device 100, based on the wireless module 120, senses that the distance between the user and the wireless device 100 changes from less than 60 cm to greater than 60 cm, the wireless device 100 transitions from the active state to the power save state, and the wireless module 120 enters the first low power mode as shown in FIG. 8.

According to some embodiments, in the power save state and the low power sensing state, the wireless module 120 enters the first low power mode. As shown in FIG. 8 and FIG. 10, the operation of the wireless module 120 entering the first low power mode includes the wireless transmission module 441, the processor 121, the memory 122, and the host control interface 445 entering the low power mode, as well as some cores of the processor 121 and some memory arrays of the memory 122 being powered off.

In some embodiments, the wireless device 100 switches to the power save state and controls the wireless module 120 to enter the first low power mode based on its battery level being lower than a predetermined value.

In some embodiments, the wireless device 100 controls the wireless module 120 to enter the first low power mode based on the wireless module 120 sensing that the user's distance from the wireless device 100 is less than a first length (e.g., 60 cm) and the user's gaze direction deviates from the host device 110 (e.g., gazing at other objects such as a newspaper).

In some embodiments, when the wireless module 120 performs sensing, the wireless device 100, based on the wireless module 120 being in the first low power mode, processes the sensed data through the collaboration of the processor 111 of the host device 110 and the processor 121 of the wireless module 120 to generate the sensing result.

For example, when switching from the power save state to the low power sensing state for sensing, the wireless module 120 is in the first low power mode as shown in FIG. 10. The wireless device 100 processes and analyzes the data sensed by the CSI sensing module 442 via the CSI sensing algorithm program 421, the CSI data preprocessing program 422, the CSI sensing algorithm program 431, and the CSI data preprocessing program 432 to generate sensing result such as the user's distance.

In operation 23, the wireless device 100 controls the wireless module 120 to exit the first low power mode based on the wireless module 120 sensing that the distance between the user and the wireless device 100 changes from greater than the first length to less than the first length.

For example, when the wireless device 100, based on the wireless module 120, senses that the distance between the user and the wireless device 100 changes from greater than 60 cm to less than 60 cm, the wireless device 100 returns from the power save state to the active state, and the wireless module 120 exits the first low power mode.

In some embodiments, when the wireless module 120 performs sensing, the wireless device 100, based on the wireless module 120 having exited the first low power mode, disables the processor 121 of the wireless module 120 from processing the sensed data and processes the sensed data via the processor 111 of the host device 110 to generate sensing results.

For example, when entering the active sensing state from the active state for sensing, the wireless module 120 has exited the first low power mode as shown in FIG. 8 and FIG. 10. The wireless device 100 processes and analyzes the data sensed by the CSI sensing module 442 only via the CSI sensing algorithm program 421 and the CSI data preprocessing program 422.

In operation 24, the wireless device 100 controls the host device 110 to enter the sleep mode and the wireless module 120 to enter a second low power mode based on the wireless module 120 sensing that the user's distance from the wireless device 100 is greater than a second length (e.g., 5 meters), wherein the second length is greater than the first length. In some embodiments, the power consumption of the wireless module 120 in the second low power mode is lower than that in the first low power mode.

For example, when the wireless device 100, based on the wireless module 120, senses that the distance between the user and the wireless device 100 changes from less than 60 cm to greater than 5 meters, the wireless device 100 transitions from the active state to the WoW power save state, and the wireless module 120 enters the second low power mode as shown in FIG. 12.

According to some embodiments, in the WoW power save state and the WoW low power sensing state, the wireless module 120 enters the second low power mode. As shown in FIGS. 12 and 14, the operation of the wireless module 120 entering the second low power mode includes the wireless transmission module 441, the processor 121, the memory 122, and the host control interface 445 entering the low power mode, as well as some cores of the processor 121, a portion of the memory 122, and a portion of the host control interface 445 being powered off.

In operation 25, the wireless device 100 controls the wireless module 120 to exit the second low power mode based on the wireless module 120 sensing that the distance between the user and the wireless device 100 changes from greater than the second length to less than the second length.

For example, when the wireless device 100, based on the wireless module 120, senses that the distance between the user and the wireless device 100 changes from less than 60 cm to greater than 5 meters, the wireless device 100 transitions from the active state to the WoW power save state, and the wireless module 120 enters a low power mode as shown in FIG. 12.

In some embodiments, the wireless device 100 powers off a portion of the host control interface 445 based on the host device 110 entering the sleep mode.

In some embodiments, when performing the wireless sensing, the wireless device 100 enables the processor 121 of the wireless module 120 to process the sensed data to generate sensing results based on the host device 110 being in the sleep mode.

As shown in FIGS. 13 and 14, based on the host device 110 being in the sleep mode, the wireless device 100 processes and analyzes the data sensed by the CSI sensing module 442 via the CSI sensing algorithm program 431 and the CSI data preprocessing program 432.

In some embodiments, after the wireless module 120 enters the second low power mode, the wireless device 100 maintains the wireless module 120 in the second low power mode based on the wireless module 120 sensing no motion in the environment.

In some embodiments, after the host device 110 enters the sleep mode, the wireless module 120 enters the second low power mode, and the wireless module 120 senses no motion in the environment; then, based on the wireless module 120 subsequently sensing motion in the environment, the wireless device 100 maintains the host device 110 in the sleep mode and controls the wireless module 120 to exit the second low power mode.

The operating methods of the system 10 and the wireless device 100 of the present disclosure (e.g., method 20 and the state switching and component control methods described in FIGS. 5 to 15) can be implemented by a non-transitory computer-readable storage medium. The non-transitory computer-readable storage medium is used to store at least one program. After the system 10 or the wireless device 100 loads and executes the at least one program, the at least one program causes the system 10 or the wireless device 100 to perform the operating methods of any embodiment of the present disclosure.

In some embodiments, the non-transitory computer-readable storage medium may be the memory 112, the memory 122, or a combination thereof. In other embodiments, the non-transitory computer-readable storage medium may be a storage component external to the wireless device 100; for example, the wireless device 100 connects to and accesses the code of the non-transitory computer-readable storage medium via a reader or a connector of the host device 110.

In summary, the systems, electronic devices, operating methods for the systems and electronic devices, and the non-transitory computer-readable storage medium of the present disclosure provide a power-saving strategy. Utilizing this power-saving strategy, the system and the electronic device can adjust their power consumption and operation modes based on environmental information obtained through wireless sensing, thereby achieving an optimal balance between power consumption and performance efficiency.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for operating an electronic device, comprising:
sensing an environment of the electronic device via a wireless module of the electronic device;
controlling the wireless module to enter a first low power mode based on the wireless module sensing that a distance between a user and the electronic device is greater than a first length;
controlling the wireless module to exit the first low power mode based on the wireless module sensing that the distance between the user and the electronic device changes from greater than the first length to less than the first length;
controlling a host device of the electronic device to enter a sleep mode and the wireless module to enter a second low power mode based on the wireless module sensing that the distance between the user and the electronic device is greater than a second length, wherein the second length is greater than the first length,
wherein power consumption of the wireless module in the second low power mode is less than power consumption of the wireless module in the first low power mode; and
controlling the wireless module to exit the second low power mode based on the wireless module sensing that the distance between the user and the electronic device changes from greater than the second length to less than the second length.

2. The method of claim 1, further comprising:
when the wireless module performs the sensing, processing sensed data obtained from the sensing through collaboration between a first processor of the host device and a second processor of the wireless module to generate a sensing result, based on the wireless module being in the first low power mode.

3. The method of claim 1, further comprising:
when the wireless module performs the sensing, processing sensed data obtained from the sensing via a first processor of the host device to generate a sensing result and disabling a second processor of the wireless module from processing the sensed data, based on the wireless module having exited the first low power mode.

4. The method of claim 1, further comprising:
powering off a portion of a host control interface of the wireless module based on the host device entering the sleep mode.

5. The method of claim 1, further comprising:
when the wireless module performs the sensing, enabling a processor of the wireless module to process sensed data obtained from the sensing to generate a sensing result, based on the host device being in the sleep mode.

6. The method of claim 1, wherein the wireless module comprises a processor having a plurality of cores and a memory having a plurality of memory arrays, wherein controlling the wireless module to enter the first low power mode comprises:
powering off a portion of the plurality of cores; and
powering off a portion of the plurality of memory arrays.

7. The method of claim 1, further comprising:
controlling the wireless module to enter the first low power mode according to a battery of the electronic device lower than a predetermined value.

8. The method of claim 1, further comprising:
controlling the wireless module to enter the first low power mode based on the wireless module sensing that the distance between the user and the electronic device is less than the first length and that a gaze direction of the user deviates from the host device.

9. The method of claim 1, further comprising:
maintaining the wireless module in the second low power mode based on the wireless module sensing no motion in the environment after the wireless module has entered the second low power mode.

10. The method of claim 1, further comprising:
after the host device has entered the sleep mode, the wireless module has entered the second low power mode, and the wireless module has sensed no motion in the environment, maintaining the host device in the sleep mode and controlling the wireless module to exit the second low power mode based on the wireless module sensing motion in the environment.

11. A non-transitory computer-readable storage medium for storing at least one program, wherein when an electronic device loads and executes the at least one program, the at least one program causes the electronic device to perform operations comprising:
sensing an environment of the electronic device via a wireless module of the electronic device;
controlling the wireless module to enter a first low power mode based on the wireless module sensing that a distance between a user and the electronic device is greater than a first length;
controlling the wireless module to exit the first low power mode based on the wireless module sensing that the distance between the user and the electronic device changes from greater than the first length to less than the first length;
controlling a host device of the electronic device to enter a sleep mode and the wireless module to enter a second low power mode based on the wireless module sensing that the distance between the user and the electronic device is greater than a second length, wherein the second length is greater than the first length,
wherein power consumption of the wireless module in the second low power mode is less than power consumption of the wireless module in the first low power mode; and
controlling the wireless module to exit the second low power mode based on the wireless module sensing that the distance between the user and the electronic device changes from greater than the second length to less than the second length.

12. The non-transitory computer-readable storage medium of claim 11, wherein when the electronic device loads and executes the at least one program, the at least one program causes the electronic device to perform the following operations:
when the wireless module performs the sensing, processing sensed data obtained from the sensing through collaboration between a first processor of the host device and a second processor of the wireless module to generate a sensing result, based on the wireless module being in the first low power mode.

13. The non-transitory computer-readable storage medium of claim 11, wherein when the electronic device loads and executes the at least one program, the at least one program causes the electronic device to perform the following operations:
when the wireless module performs the sensing, processing sensed data obtained from the sensing via a first processor of the host device to generate a sensing result and disabling a second processor of the wireless module from processing the sensed data, based on the wireless module having exited the first low power mode.

14. The non-transitory computer-readable storage medium of claim 11, wherein when the electronic device loads and executes the at least one program, the at least one program causes the electronic device to perform the following operations:
powering off a portion of a host control interface of the wireless module based on the host device entering the sleep mode.

15. The non-transitory computer-readable storage medium of claim 11, wherein when the electronic device loads and executes the at least one program, the at least one program causes the electronic device to perform the following operations:
when the wireless module performs the sensing, enabling a processor of the wireless module to process sensed data obtained from the sensing to generate a sensing result, based on the host device being in the sleep mode.

16. The non-transitory computer-readable storage medium of claim 11, wherein the wireless module comprises a processor having a plurality of cores and a memory having a plurality of memory arrays, wherein controlling the wireless module to enter the first low power mode comprises:
powering off a portion of the plurality of cores; and
powering off a portion of the plurality of memory arrays.

17. The non-transitory computer-readable storage medium of claim 11, wherein when the electronic device loads and executes the at least one program, the at least one program causes the electronic device to perform the following operations:
controlling the wireless module to enter the first low power mode according to a battery of the electronic device lower than a predetermined value.

18. The non-transitory computer-readable storage medium of claim 11, wherein when the electronic device loads and executes the at least one program, the at least one program causes the electronic device to perform the following operations:
controlling the wireless module to enter the first low power mode based on the wireless module sensing that the distance between the user and the electronic device is less than the first length and that a gaze direction of the user deviates from the host device.

19. The non-transitory computer-readable storage medium of claim 11, wherein when the electronic device loads and executes the at least one program, the at least one program causes the electronic device to perform the following operations:
maintaining the wireless module in the second low power mode based on the wireless module sensing no motion in the environment after the wireless module has entered the second low power mode.

20. The non-transitory computer-readable storage medium of claim 11, wherein when the electronic device loads and executes the at least one program, the at least one program causes the electronic device to perform the following operations:
after the host device has entered the sleep mode, the wireless module has entered the second low power mode, and the wireless module has sensed no motion in the environment, maintaining the host device in the sleep mode and controlling the wireless module to exit the second low power mode based on the wireless module sensing motion in the environment.
